(19) United States
(12) Patent Application Publication
(10) Pub. No.: US 2003/0183602 A1
(43) Pub. Date: Oct. 2, 2003

(54) Method of resistance spot welding

(76) Inventor: Russell Vernon Hughes, Redford, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/401,295

(22) Filed: Mar. 27, 2003

Related U.S. Application Data
(60) Provisional application No. 60/368,287, filed on Mar. 28, 2002.

(51) Int. Cl. B23K 11/10

(52) U.S. Cl. 219/92; 219/86.1

(57) ABSTRACT

A method and assembly for spot welding metal sheets includes a conductive metal strip sandwiched between an electrode and the sheet metal to be welded. The conductive strip shields the electrodes from deterioration accelerating coatings present on the sheet metal to be welded. The conductive strip deteriorates instead of the electrode and is indexed through the welding interface after a desired number of welds.

### This application claims priority to U.S. Provisional application serial No. 60/368,287 filed on Mar. 28, 2002.

### BACKGROUND OF THE INVENTION

This invention relates generally to a spot welding assembly and specifically to a spot welding assembly and method for increasing electrode life.

Typically, a spot weld is accomplished by placing two or more overlapping sheets of material between a pair of opposing electrodes. The electrodes are forced towards each other to clamp the material therebetween. A current is then supplied through each of the electrodes and the material to be welded. The current creates heat within the members to be welded to form the spot weld. Careful control of the clamping force and current through the electrodes adjusts the welding process.

Typically, the electrodes are formed of copper or alloys of copper. The heat generated at the electrodes is often dissipated by conduction or by means of a cooling system disposed within each of the electrodes. These conventional types of cooling are usually sufficient to protect the electrodes over hundreds or even thousands of welds. As appreciated, each weld causes some amount of deterioration of the electrodes.

Although electrodes typically last for extended periods, introduction of new materials including coatings causes deterioration of the electrodes to occur at a more rapid pace. Coatings provided on the welded sheet metal cause increased deterioration of the electrodes such that each electrode may need to be replaced after very few welds. One such coating is comprised of zinc, which tends to alloy with the copper-based electrodes. As appreciated, the combination of zinc with the copper electrodes degrades the performance of the electrodes to the point of requiring frequent replacement. Further, the introduction of aluminum and magnesium repeat alloys within the automotive industry has created increased problems with electrode life. Attempts at elongating the life of the electrodes have been largely unsuccessful. Such attempts include the development of different electrode materials to extend the useful life. However, such attempts have only increased cost and provided only limited success in lengthening the useful life of the electrodes.

Accordingly, it is desirable to develop a device and process capable of welding coated sheet material without substantially degrading the electrode surfaces and causing the need for frequent electrode changes.

### SUMMARY OF THE INVENTION

The present invention is a method and assembly for spot welding metal sheets comprising a conductive metal strip sandwiched between an electrode and a metal sheet that substantially reduces deterioration of the electrodes caused by the spot welding process.

The spot welding assembly of this invention includes two electrodes opposing each other to sandwich two or more sections of sheet metal. The assembly includes an electrically conductive strip sandwiched between the electrode and the metal sheet to be welded. The conductive strip is indexed through a welding interface between the electrode and the metal sheet such that a portion of the conductive strip within the interface is substantially clean to optimize the welding process. The conductive strip shields the electrode from deterioration accelerating coatings present on the metal sheet surface. The conductive strip deteriorates instead of the electrode. The conductive strip is indexed through the welding interface such that after a desired number of welds a new portion of the conductive strip is sandwiched between the electrodes and the metal sheet to be welded.

The assembly and method of this invention substantially increases the life of the electrodes by providing a sacrificial material that is easily changed or indexed such that attention or maintenance of the welding process can be done substantially infrequently as compared to conventional methods.

### BRIEF DESCRIPTION OF THE DRAWINGS

The various features and advantages of this invention will become apparent to those skilled in the art from the detailed description of the currently preferred embodiment. The drawings that accompany the detailed description can be briefly described as follows:

FIG. 1 is schematic representation of a spot welding machine;

FIG. 2 is a schematic representation of an electrode assembly for a spot welding machine;

FIG. 3 is an enlarged view of the electrode assembly during the spot welding process;

FIG. 4A is a top view of the sacrificial conductive strip after several spot welding cycles; and

FIG. 4B is a top view of the sacrificial conductive strip with perforations to allow positive advancement.

### DETAILED DESCRIPTION OF THE PREFERRED EMBODIMENT

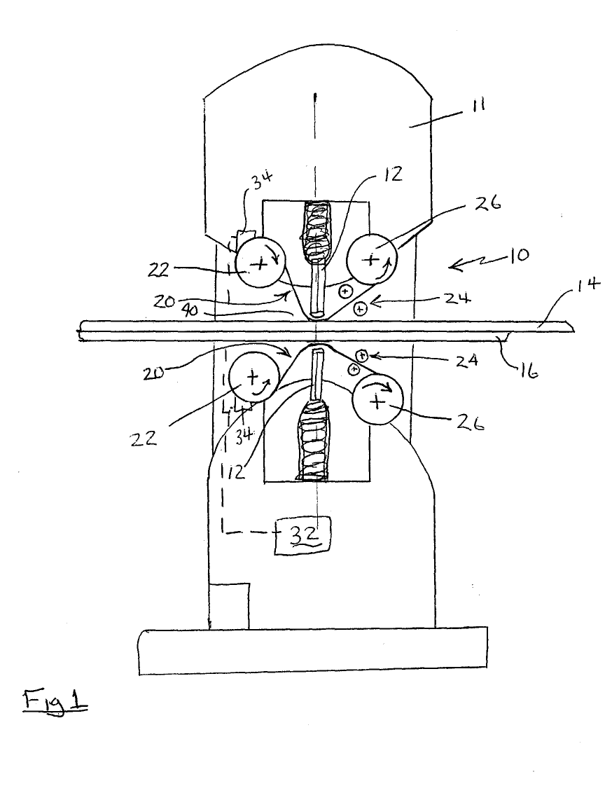

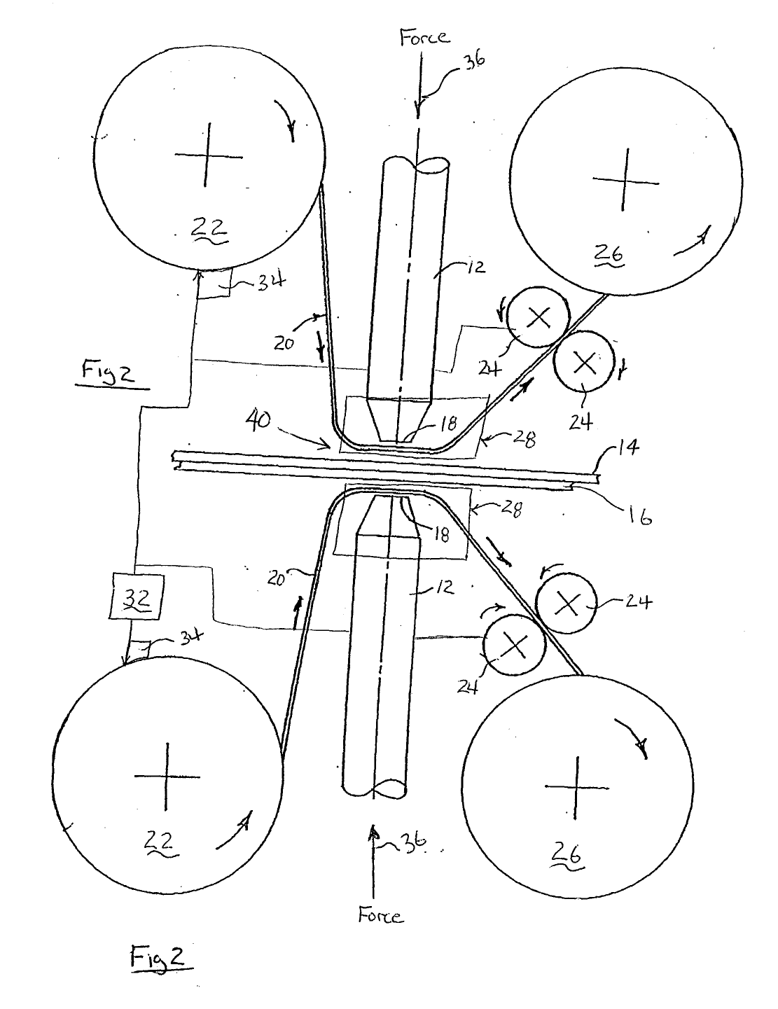

Referring to FIGS. 1 and 2, the present invention is a spot welding machine 11 having an electrode assembly 10. The electrode assembly 10 comprises electrodes 12 disposed on opposite sides of the sheet material 14, 16. A supply spool 22 is supported on the machine 11 for each of the electrodes 12 and includes electrically conductive strip 20. The conductive strip 20 comprises a material such as copper placed between the electrodes 12 and the sheet material 14, 16 during a spot welding process.

The conductive strip 20 is a sacrificial metal material indexed after a predetermined number of spot welding operations. The conductive strip 20 is indexed from the supply spool 22 to a welding interface 40 between the electrode 12 and metal sheets 14, 16. The conductive strip 20 is then pulled through a guide mechanism 28, schematically shown, by drive wheels 24. A receiving spool 26 gathers advancing and worn conductive strip 20. The drive wheels 24 and supply spool 22 are in communication with a controller 32. The controller 32 controls movement of the conductive strip 20 through the interface 40 and the guide mechanism 28.

The driven rollers 24 are only one means within the contemplation of this invention for indexing the conductive strip 20 through the welding interface 40. It is within the contemplation of this invention that any means known by a worker skilled in the art may be used to index the conductive strip 20 through the welding area. The conductive strip 20 is collected in the receiving spools 26. The collected conductive strip 20 can then be disposed of or recycled for use in other processes.

Each of the electrodes 12 includes a face 18. The face 18 is the part of the electrode that contacts the conductive strip 20. The face 18 of the electrode 12 would be substantially degraded after only a few welds if not for the sacrificial conductive strip, 20 disposed between the face 18 and the sheet materials 14, 16.

The controller 32 controls movement of the conductive strip 20 through the welding interface 40 to the receiving spool 26. The controller 32 is in communication with sensors 34 monitoring movement of the conductive strip 20 in order to prevent kinking twisting, or bunching caused by possible sticking of the conductive strip 20 after a spot weld. Further, the guide mechanism 28 aligns the conductive strip 20 within the welding zone and the face 18 of each electrode 12 during each spot welding process.

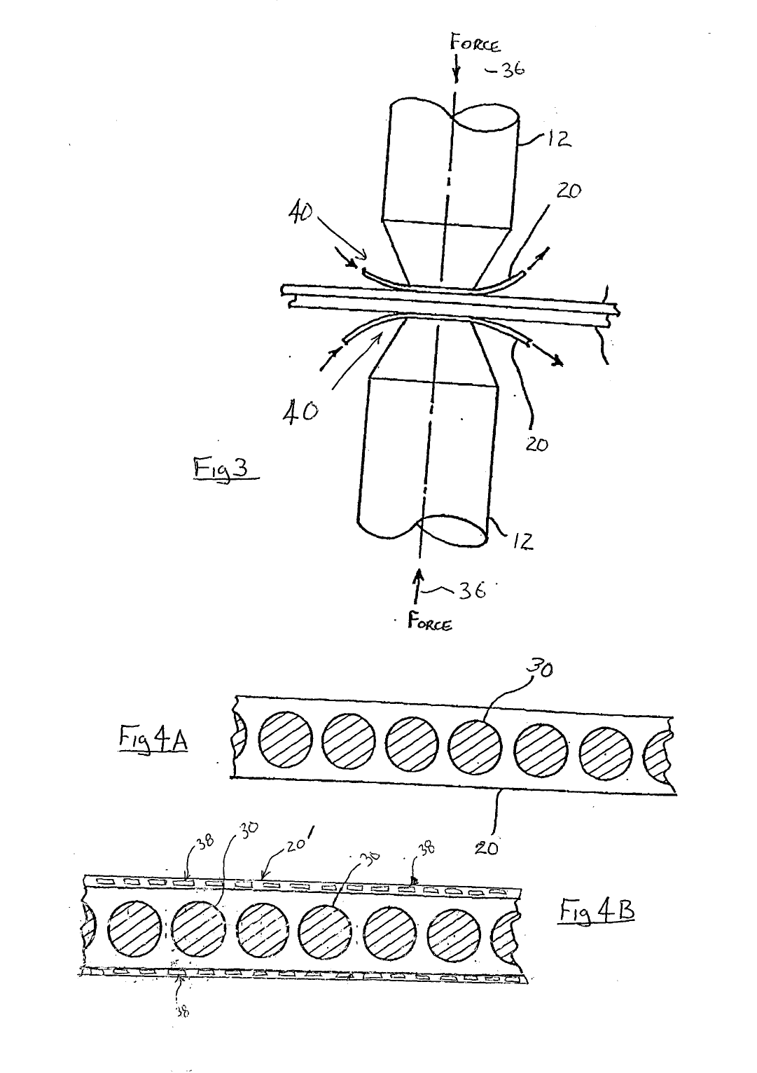

Referring to FIG. 3, in operation the electrodes 12 are forced towards each other to trap and clamp the sheet material 14, 16 therebetween. The conductive strip 20 is sandwiched between the electrodes 12 and the sheet materials 14,16. The sheet materials 14,16 are held under a desired pressure that corresponds to the welding current flowing through each electrode 12. The specific thickness of the sheet material and of the conductive strip 20 dictate the amount of pressure exerted in the direction indicated by arrows 36. A worker skilled in the art would understand that sheet material of different thicknesses and spot welds of different areas require differing pressures and currents and would be within the contemplation of this invention.

In operation, each electrode 12 is forced towards each other to clamp the material 14 and 16 along with the conductive strip 20 therebetween. An electric current is initiated through the electrodes 12 creating a heat-affected zone fusing the sheet material 14,16 together. The amount of heat exerted by the electrodes 12 is determined to weld only the sheet material 14,16 together leaving the conductive strip 20 free after the welding process. Once the weld is completed, the electrodes 12 are withdrawn to allow for movement of the sheet material 14,16. The conductive strip 20 is indexed such that an area of fresh conductive strip 20 is exposed between the electrodes 12 and the sheet material 14,16. The thickness of the conductive strip 20 is determined to prevent breakage during the welding and feeding process and offer minimal resistance to current flow between the electrodes 12.

Referring to FIGS. 4A and 4B, the conductive strip 20 is shown after multiple welding processes. Each spot welding process will result in a shaded area 30 that illustrates deterioration caused by coatings applied to the sheet materials 14,16. The conductive strip 20 can be fabricated from any conductive material including copper, titanium, brass, etc. The use of titanium or other stronger more exotic materials increases the number of weld cycles that can be performed using a particular portion of conductive strip 20. As appreciated, the selection of specific material for the conductive strip 20 will vary depending on application specific welding parameters. A worker skilled in the art with the benefit of this disclosure would be able to select specific materials compatible with a specific welding application.

Referring to FIG. 4B, an embodiment of the conductive strip 20′ includes a plurality of perforations 38 along each edge to provide for positive engagement to the driven rollers 24. The perforations 38 are similar to those commonly used for advancing the film in a camera. Further, the conductive strip 20′ may be housed within a cassette type assembly that provides for easy change out. The ease of change out is particularly useful in production applications.

The conductive strip 20 of this invention provides a sacrificial layer between the electrode 12 and the material being welded. The conductive strip 20 isolates the materials of the electrode from the materials of the welded material to prevent undesired deteriorations of the electrodes 12 caused by destructive material combinations.

The foregoing description is exemplary and not just a material specification. The invention has been described in an illustrative manner and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention.

What is claimed is:

1. A spot welding assembly comprising:
a first electrode for welding a metal sheet; and
a first electrically conductive strip disposed between said electrode and said metal sheet for isolating said electrode from said metal sheet.

2. The assembly of claim 1, further comprising a second electrode, and a second conductive strip disposed on a side opposite said first electrode and said first conductive strip.

3. The assembly of claim 1, further comprising a supply spool and a receiving spool, said conductive strip advancing from said supply spool to said electrode and up to said receiving spool.

4. The assembly of claim 3, further comprising a guide for aligning said conductive strip with said electrode.

5. The assembly of claim 1, further comprising a controller, said controller programmed for advancing said conductive strip in response to a desired number of welds.

6. The assembly of claim 4, wherein said guide includes a sprocket comprising a plurality of teeth engaging a series of openings within said conductive strip.

7. The assembly of claim 1, wherein said conductive strip is wound within a supply spool and advances past said electrode and into a receiving spool.

8. The assembly of claim 1, wherein said conductive strip comprises a copper material.

9. The assembly of claim 1, wherein said conductive strip includes titanium.

10. A electrode assembly for a spot welder comprising:
a first electrode directing energy for welding a metal sheet;
a conductive strip threaded from a supply spool through an interface between said electrode and a metal sheet to a receiving spool.

11. The assembly of claim 10, wherein said conductive strip is disposed between said electrode on a first side and said metal sheet on a second side.

12. The assembly of claim 10, wherein a portion of said conductive strip within said interface wears in response to welding of said metal strip.

13. The assembly of claim 12, wherein said portion of said conductive strip is advanced out of said interface after a desired number of welds.

14. The assembly of claim 10, wherein said conductive strip provides a sacrificial covering between said electrode and said metal sheet, thereby substantially reducing wear caused by use of said electrode.

15. The assembly of claim 10, further comprising a second electrode disposed on a second side of said metal sheet, and a second conductive strip threaded from a second supply spool through a second interface between said second electrode and said second side of said metal sheet to a second receiving spool.

16. A method of spot welding metal sheets, said method comprising the steps of:
a) threading an electrically conductive strip through an interface between an electrode and a metal sheet;
b) sandwiching said conductive strip between said electrode and said metal sheet, and
c) applying electrical energy with said electrode through said conductive strip to form a weld in said metal sheet.

17. The method of claim 16, further comprising the step of retracting a worn portion of said conductive strip from said interface and advancing a non-worn portion of said conductive strip into said interface in response to a predetermined condition.

18. The method of claim 16, wherein step a) further comprises guiding said conductive strip from a supply spool through said interface and into a receiving spool.

19. The method of claim 16, wherein step b) further comprises applying a predetermined amount of force with said electrode against said conductive strip and said metal sheet.

20. The method of claim 16, further comprising at least two electrodes and two conductive strips disposed on opposite sides of said metal sheet.
